(19) United States
(12) Patent Application Publication
(10) Pub. No.: US 2003/0108363 A1
(43) Pub. Date: Jun. 12, 2003

(54) Developing roller and manufacturing method thereof

(75) Inventor: Ki-Jae Do, Suwon-City (KR)

Correspondence Address: STAAS & HALSEY LLP, 700 11TH STREET, NW, SUITE 500, WASHINGTON, DC, 20001, US

(73) Assignee: Samsung Electronics Co., Ltd., Suwon-City (KR)

(21) Appl. No.: 10/310,890

(22) Filed: Dec. 6, 2002

(30) Foreign Application Priority Data
Dec. 8, 2001 (KR) 2001-77647

(51) Int. Cl. G03G 15/08

(52) U.S. Cl. 399/279

(57) ABSTRACT

A developing roller installed in an image forming apparatus to transfer a toner to a photosensitive member and a manufacturing method of the developing roller include a roller member having an outer cylindrical vessel, an inner vessel installed within the outer cylindrical vessel in concentric with the outer cylindrical vessel, a hollow portion formed at a center of the inner vessel, and a plurality of ribs connecting and supporting the outer cylindrical vessel and the inner vessel so as to connect and support the outer cylindrical vessel and the inner vessel, and a rotating shaft compressively fitted into the hollow portion of the inner vessel. The developing roller as stated above is manufactured by integrally extruding and drawing the outer cylindrical vessel, the inner vessel, and the ribs, cutting them into a desired length, grinding an outer circumferential surface of the outer cylindrical vessel and an inner circumferential surface of the hollow portion to have a desired precision to complete the roller member, and fitting the processed rotating shaft into the hollow portion by applying a pressure to the processed rotating shaft and the hollow portion.

### CROSS-REFERENCE TO RELATED APPLICATIONS

This application claims the benefit of Korean Patent Application No. 2001-77647, filed Dec. 8, 2001, in the Korean Intellectual Property office, the disclosure of which is incorporated herein by reference.

### BACKGROUND OF THE INVENTION

1. Field of the Invention

The present invention relates to a developing roller and a manufacturing method of the developing roller that is used in an image forming apparatus, e.g., a copying machine, a facsimile, a printer or the like, and installed in a developing device utilizing a one component type developer, such as toner, to transfer the toner.

2. Description of the Related Art

Generally, an electrophotographic image forming apparatus develops an electrostatic latent image with a developer when visualizing the electrostatic latent image on a photosensitive member. In the image forming apparatus, it is advantageous to use a mono component type developer containing toner only in view of size, cost, and reliability of the image forming apparatus. Additionally, in a case of a development of a color image, it is advantageous to use nonmagnetic toner having a high transparency feature in view of an image quality.

An image forming process of the electrophotographic image forming apparatus utilizing the nonmagnetic toner will be described as follows.

The electrostatic latent image is formed on the photosensitive member by electrically charging the photosensitive member with a charging unit and radiating light on a charged region of the photosensitive member. The nonmagnetic toner is supplied to a developing roller by a toner supply roller, and the toner conveyed to the developing roller is laminated to a layer having a uniform thickness by a layer regulation member as well as electrically charged with a high friction force. The toner passed through the layer regulation member is used for developing a toner image corresponding to the electrostatic latent image, and this developed toner image is transferred to a substrate, such as a sheet of paper, with a transfer roller. The transferred toner image subsequently is affixed to the substrate by a suitable fixing unit, and the toner remaining on the photosensitive member after transfer of the developed image is scraped off from the photosensitive member by a cleaning device.

As described above, the developing roller installed in the developing device is supplied with the toner from the toner supply roller. The developing roller rotates so that the laminated toner on the developing roller can be conveyed to contact the photosensitive member. FIG. 1 is a cross sectional view illustrating the developing roller having a tubular body 10 transferring the toner applied thereon, and flanges 20a, 20b constructed to be fitted in both ends of the tubular body 10 transmitting a rotating force to the tubular body 10.

Outer diameter portions of the flanges 20a, 20b are processed to correspond to inner diameter portions of both ends of the tubular body 10 so as to be compressively fitted into the both ends of the tubular body 10. Since the developing roller rotates according to a rotation of the flanges 20a, 20b compressively fitted therein, the outer diameter portions of the flanges 20a, 20b and the inner diameter portions of the tubular body 10 should be ground so as to prevent shaking of the flanges 20a, 20b fitted in the tubular body 10. Unfortunately, a shaking tolerance of the outer diameter portion about a rotating shaft can occur if a manufacturer fails to comply with a desired shape precision required for the developing roller, thus resulting in an irregular image. Additionally, when an alternating current is applied to the developing roller, noise would occur from the developing roller.

### SUMMARY OF THE INVENTION

Accordingly, it is an aspect of the present invention to provide a developing roller capable of keeping a high shape precision by simplifying a manufacturing process of the developing roller that will be installed in an image forming apparatus transferring a toner.

Additional aspects and advantages of the invention will be set forth in part in the description which follows and, in part, will be obvious from the description, or may be learned by practice of the invention.

A developing roller is provided to achieve the above and/or other aspects of the present invention. The developing roller includes an outer vessel, an inner vessel installed within and concentric with the outer vessel and formed with a hollow portion at a center thereof, a plurality of ribs provided along a longitudinal direction of the outer vessel and the inner vessel so as to connect and support the outer vessel and the inner vessel, and a rotating shaft compressively fitted into the hollow portion of the inner vessel. The inner vessel can be processed into a polygonal portion as well as a cylindrical portion, and the hollow portion can be formed to have a circular or polygonal cross section so as to perforate the inner vessel.

A manufacturing method of the developing roller to achieve the above and other objects of the present invention includes forming the roller member having the outer vessel, the inner vessel installed within the outer vessel in concentric with the outer vessel and formed with the hollow portion at the center thereof, the ribs provided along the longitudinal direction of the outer vessel and the inner vessel so as to connect and support the outer vessel and the inner vessel, grinding an outer circumferential surface of the outer vessel and an inner circumferential surface of the hollow portion to have a desired precision after cutting the roller member into a desired length, processing a rotating shaft, and fitting the rotating shaft into the hollow portion by applying a pressure to the rotating shaft and the hollow portion.

### BRIEF DESCRIPTION OF THE DRAWINGS

These and other objects and advantageous of the invention will become apparent and more readily appreciated from the following description of the preferred embodiments, taken in conjunction with the accompanying drawings of which:

FIG. 1 is a cross sectional view illustrating a typical prior art developing roller;

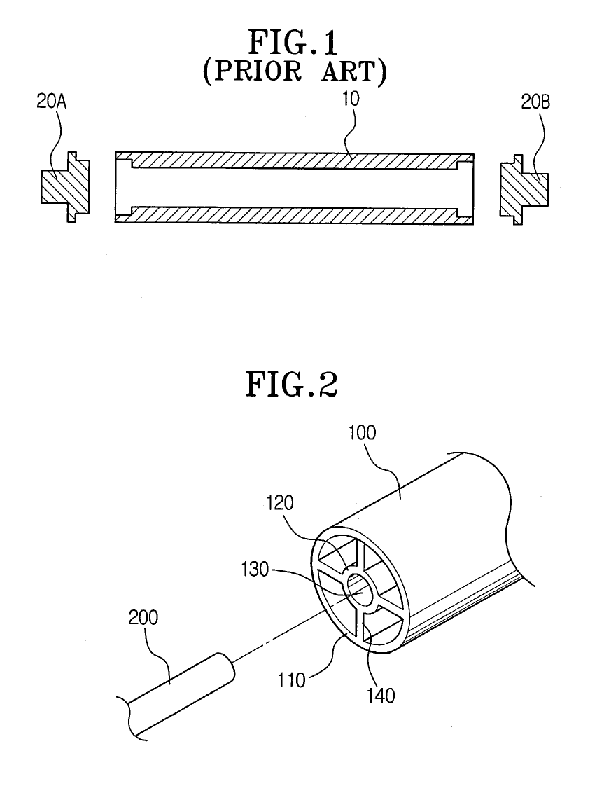

FIG. 2 is a perspective view illustrating a developing roller in accordance with one embodiment of the present invention; and

FIGS. 3A to 3E are cross sectional views illustrating several developing rollers according to other embodiments of the present invention.

### DETAILED DESCRIPTION OF THE PREFERRED EMBODIMENTS

Reference will now be made in detail to the present preferred embodiments of the present invention, examples of which are illustrated in the accompanying drawings, wherein like reference numerals refer to the like elements throughout. The embodiments are described in order to explain the present invention by referring to the figures.

The present invention will be described in more detail with reference to the drawings.

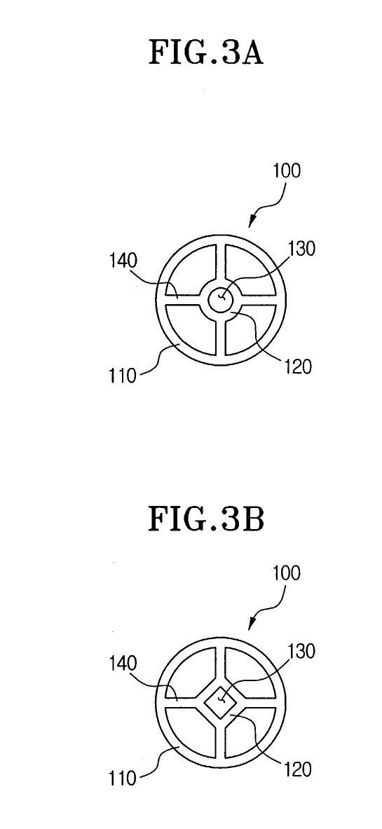

FIG. 2 is a perspective view illustrating a developing roller in accordance with an embodiment of the present invention. As shown in FIG. 2, the developing roller includes a roller member 100 and a rotating shaft 200. The roller member 100 includes an outer vessel 110, an inner vessel 120 provided inside the outer vessel, a hollow portion 130 formed at a center of the inner vessel 120, and a plurality of ribs 140 connecting the outer vessel 110 and the inner vessel 120. The ribs extend from the inner vessel 120 to the outer vessel 110 in a radial direction of the roller member 100. A space between the outer vessel 110 and the inner vessel 120 is divided into a plurality of chambers. The rotating shaft 200 has a cross sectional shape corresponding to a shape of the hollow portion 130 so that it can be compressively fitted in the hollow portion.

A manufacturing method of the developing roller as described above now will be described as follows.

First, one material selected among aluminum having a purity of more than 99.5%, a copper-aluminum alloy containing copper of 0.05 to 0.20%, a copper-manganese-aluminum alloy containing copper of 0.05 to 0.20% and manganese of 1.0 to 1.5%, a silicon-coppermanganese-aluminum alloy containing silicon of 0.20 to 0.60% and magnesium of 0.45 to 0.90%, and so on, is molded into a semi-finished product by performing extrusion molding and drawing processes. The semi-finished product having an integral pipe shape is cut into a desired length suitable for the developing roller, and then an outer circumferential surface of the semi-finished product is ground and polished to achieve a desired precision. In addition, an inner circumferential surface of the hollow portion 130 and an outer circumferential surface of the rotating shaft 200 are ground so that the rotating shaft 200 can be compressively fitted into the hollow portion 130 without a tolerance.

After the outer vessel 110 is extruded into a cylindrical form having a desired thickness, an outer diameter portion of the outer vessel 100 is ground to achieve a desired shape precision required for the developing roller. The outer circumferential surface of the outer cylindrical vessel 110 is formed so as to conform a surface roughness (flatness) of 0 to 9 μm required for frictional electrification and transfer of toner. Also, in order to prevent an unintentional abrasion of the outer circumferential surface of the outer vessel, the outer circumferential surface of the outer vessel 110 is plated (coated) with electroless nickel-phosphorous, electroless lead-phosphorous, or electroless chrome.

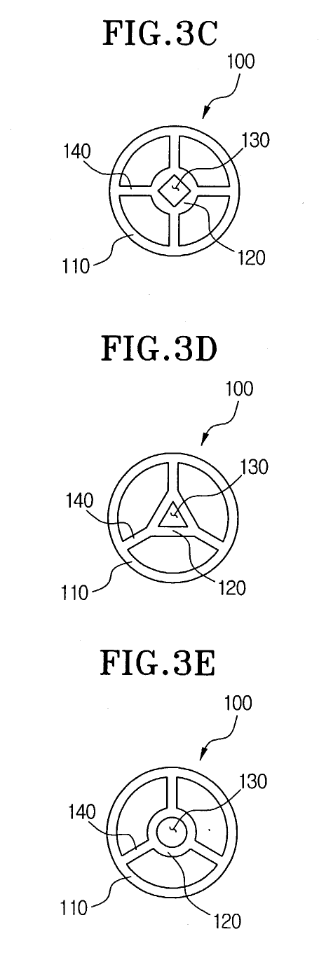

The inner vessel 120 is disposed to be concentric with the outer vessel 110 and within the outer vessel 110 and is shaped to have a polygonal cross section including a quadrangle, a triangle, and so on, as well as a circle as shown in FIGS. 3A to 3E. The hollow portion 130 is formed at the center of the inner vessel 120 formed as described above, and the rotating shaft 200 can be inserted into the hollow portion 130. The hollow portion 130 also is shaped into a polygonal form including a quadrangle, a triangle, and so on, as well as a circle as shown in FIGS. 3A to 3E. FIGS. 3A to 3E are cross sectional views illustrating several different embodiments of the roller member according to the present invention. As shown in the drawings, the inner vessel 120 and the hollow portion 130 are formed into various shapes.

The rotating shaft 200 is fitted into the hollow portion 130 so that the roller member 100 can be rotated for the transfer of toner. A shape of the rotating shaft depends on a shape of the hollow portion. For example, if the hollow portion has a triangular cross section, the rotating shaft is formed into a triangular prism, and if the hollow portion has a square cross section, the rotating shaft is formed into a square prism. In addition, the rotating shaft 200 is divided into two pieces each fitted into corresponding ones of both ends of the hollow portion 130, respectively, or is integrally formed into a single body so as to be inserted into the hollow portion through one end of the hollow portion 130. The ribs 140 are provided between the outer vessel 1 10 and the inner vessel 120 to support the outer vessel 110 and the inner vessel 120 spaced-apart from the outer vessel 110.

The developing roller is installed so that a gap between a photosensitive member (not shown) and the developing roller is wider than a thickness of a toner layer formed on the developing roller. An electric current to be applied to the developing roller is selected among a direct current, or an overlap current of the direct current and the alternating current. In addition, a nonmagnetic developer can be used.

The developing roller constructed as described above is rotated according to a rotation of the rotating shaft 200 compressively fitted in the hollow portion 130, and the toner supplied to the developing roller with a toner supply roller (not shown) is laminated to a uniform thickness by a layer regulation member as well as electrically charged with high frictional electricity.

Since the developing roller according to the present invention is integrally molded by performing the extrusion molding and drawing processes, a manufacturing process of the developing roller becomes very simple, thus a working precision required for the developing roller will be improved, resulting in reduction of a manufacturing cost.

According to the present invention, since the outer vessel, the inner vessel, and the hollow portion are integrally extruded and drawn, and since the rotating shaft is compressively fitted into the hollow portion, shaking tolerance of the outer diameter portion about the rotating shaft can be reduced, thereby achieving a uniform image and reducing noise generated when the alternating current is applied.

While a few preferred embodiments of the present invention have been shown and described, it will be understood by those skilled in the art that various changes may be made in this embodiment without departing from the principles and spirit of the invention, the scope of the invention as defined by the appended claims and their equivalents.

What is claimed is:

1. A developing roller transferring toner to develop an electrostatic latent image in an image forming apparatus, comprising:
an outer vessel;
an inner vessel installed within the outer vessel and concentric with the outer vessel and formed with a hollow portion at a center thereof;
a plurality of ribs provided along a longitudinal direction of the outer vessel and the inner vessel so as to connect and support the outer vessel and the inner vessel; and
a rotating shaft compressively fitted into the hollow portion of the inner vessel.

2. The developing roller of claim 1, wherein the inner vessel has a cylindrical form.

3. The developing roller of claim 1, wherein the inner vessel has a polygonal form.

4. The developing roller of claim 1, wherein the hollow portion has a circular cross-section and is formed in the inner vessel.

5. The developing roller of claim 1, wherein the hollow portion has a polygonal cross-section and is formed in the inner vessel.

6. A manufacturing method of a developing roller of an image forming apparatus, the method comprising:
forming a roller member having an outer vessel, an inner vessel installed within the outer vessel in concentric with the outer vessel, a hollow portion formed at a center of the inner vessel, and a plurality of ribs provided along a longitudinal direction of the outer vessel and the inner vessel so as to connect and support the outer vessel and the inner vessel;
grinding an outer circumferential surface of the outer vessel and an inner circumferential surface of the hollow portion to have a precision after cutting the roller member into a length;
processing a rotating shaft; and
fitting the rotating shaft into the hollow portion by applying a pressure to the rotation shaft and the hollow portion.

7. The manufacturing method of claim 6, wherein the forming of the roller member comprises:
extruding one material selected among aluminum, an alloy of copper and aluminum, an alloy of copper, manganese, and aluminum, and an alloy of silicon, magnesium, and aluminum.

8. The manufacturing method of claim 6, wherein the grinding of the outer circumferential surface of the outer vessel comprises:
causing the outer circumferential surface of the roller member to have a surface roughness in a range of 0 to 9 μm.

9. The manufacturing method of claim 6, further comprising:
plating the outer circumferential surface of the roller member with one material selected among electroless nickel-phosphorous, electroless lead-phosphorous, and electroless chrome.

10. The manufacturing method of claim 6, wherein the forming of the roller member comprises:
extruding one material selected among aluminum having a purity of more than 99.5%, a copper-aluminum alloy containing copper of 0.05 to 0.20%, a copper-manganese-aluminum alloy containing copper of 0.05 to 0.20% and manganese of 1.0 to 1.5%, a silicon-copper-manganese-aluminum alloy containing silicon of 0.20 to 0.60% and magnesium of 0.45 to 0.90% using extrusion molding and drawing processes.

11. The manufacturing method of claim 6, wherein the forming of the roller member comprises:
forming the outer vessel, the inner vessel, and the ribs in a single monolithic body.

12. The manufacturing method of claim 6, wherein the forming of the roller member comprises:
forming the ribs extending from the inner vessel to the outer vessel in a radial direction of the roller member.

13. The manufacturing method of claim 6, wherein the forming of the roller member comprises:
forming a chamber between the ribs and between the outer vessel and the inner vessel.

14. The manufacturing method of claim 6, wherein the forming of the roller member comprises:
forming the inner vessel to be spaced-apart from the outer vessel by a length of the ribs in a radial direction of the roller member.

15. The manufacturing method of claim 6, wherein the forming of the roller member comprises:
forming the ribs to be spaced-apart from each other between the inner vessel and outer vessel.

16. The manufacturing method of claim 6, wherein the forming of the roller member comprises:
forming the ribs to be disposed around the inner vessel at an interval in a circular direction of the roller member.

17. The manufacturing method of claim 6, wherein the rotation shaft comprises first and second rotation shafts, and the fitting of the rotation shaft comprises:
inserting the first and second rotation shafts into the hollow portion through corresponding ones of ends of the hollow portion.

18. The manufacturing method of claim 6, wherein the fitting of the rotation shaft comprises:
inserting the rotation shaft into the hollow portion through one end of the hollow portion.

19. A developing roller transferring toner to develop an electrostatic latent image in an image forming apparatus, comprising:
an outer vessel;
an inner vessel disposed in the outer vessel to be spaced-apart from the outer vessel;
a hollow portion formed in the inner vessel;
a rib formed between the inner vessel and the outer vessel in a radial direction of the inner vessel; and
a rotating shaft inserted into the hollow portion.

20. The developing roller of claim 19, wherein the outer vessel, the inner vessel, and the rib are formed in an integrated monolithic body.

21. The developing roller of claim 19, wherein the outer vessel, the inner vessel, and the rib comprise one of aluminum, an alloy of copper and aluminum, an alloy of copper, manganese, and aluminum, and an alloy of silicon, magnesium, and aluminum.
